(19) United States
(12) Patent Application Publication
(10) Pub. No.: US 2015/0052799 A1
(43) Pub. Date: Feb. 26, 2015

(54) APPARATUS FOR CAPTURING FRUIT FLIES

(71) Applicant: Michael D. Bernhardt, Buffalo, NY (US)

(72) Inventor: Michael D. Bernhardt, Buffalo, NY (US)

(21) Appl. No.: 13/971,202

(22) Filed: Aug. 20, 2013

(51) Int. Cl. A01M 1/10; A01M 1/12; A01M 1/02

(52) U.S. Cl. CPC A01M 1/106; A01M 1/02; A01M 1/12
USPC 43/107

(57) ABSTRACT

Disclosed herein is a trap for flying pests that does not require the use of chemicals and can be packaged in such a way that it can be present in public areas without being unsightly or intrusive. The trap is reusable, easy to set up, easy to clean, and easy to operate. An example trap includes a gathering vessel, fluid trap, conduit, vacuum, and timing device. The gathering vessel includes a container to hold attractant bait. One end of the conduit is coupled to the gathering vessel and the other end designed to be submerged within fluid inside the fluid trap. The vacuum is coupled to the fluid trap and removes air from the fluid trap to cause air and flies to flow from the gathering vessel, through the conduit, and into fluid inside the fluid trap. The timing device periodically activates and deactivates the vacuum.

### BACKGROUND OF THE INVENTION

Fruit flies contaminate food, wreak havoc on the liquor stores of bars and restaurants, and destroy crops; costing money in wasted product and lost produce. Conventional methods for attempting to remove these pests often employ toxic chemicals and physical traps, such as, for example, dangling adhesive tapes. While these methods may successfully remove some flies from a local environment, they also have downsides. In a business environment, especially for a food service, a dangling tape of dead flies is neither sanitary nor something that should be observed by the clientele. In the case of chemical traps, toxic chemicals pose health risks if not handled or disposed properly.

### SUMMARY OF THE INVENTION

Disclosed herein is a trap for flies that does not require the use of chemicals and is capable of being packaged in such a way that it could be present in public areas without being unsightly or intrusive. The trap also isolates the trapped flies in a container, separating them from the outside environment completely, unlike traditional traps and tapes. In addition, traditional trap systems generally must be disposed and replaced. The disclosed trap, on the other hand, is reusable, easy to set up, easy to clean, and easy to operate.

One example embodiment of the present invention is a fly trap that includes a gathering vessel, fluid trap, conduit, vacuum, and timing device. The gathering vessel includes a container to hold fly-attracting bait. The gathering vessel also includes a first opening allowing the flies to enter the gathering vessel and a second opening allowing for collection of the flies. The fluid trap is able to be partially filled with fluid. The conduit has a first end coupled to the second opening of the gathering vessel and a second end to be submerged within fluid inside the fluid trap. The vacuum is coupled to the fluid trap and removes air from the fluid trap to cause air and flies to flow from the gathering vessel, through the conduit, and into fluid inside the fluid trap. The timing device is electronically coupled to the vacuum and periodically activates and deactivates the vacuum.

In some embodiments, the container is suspended inside the gathering vessel, and the gathering vessel may include a platform near the container for the flies to land. The interior of the gathering vessel can include a low-friction surface (e.g., coated with polytetrafluoroethylene) to reduce the flies' ability to stay in the gathering vessel when the vacuum is activated. In many embodiments, the timing device is configured to activate the vacuum for a first amount of time and deactivate the vacuum for a second amount of time, where the second amount of time is longer than the first amount of time. The vacuum may also include baffles to reduce noise emitted from the vacuum

Another example embodiment of the present invention is a fly trap that includes a housing, gathering vessel, fluid trap, conduit, vacuum, and timing device. The gathering vessel is coupled to the housing and includes a container to hold fly-attracting bait. The gathering vessel also includes a first opening allowing the flies to enter the gathering vessel and a second opening allowing for collection of the flies. The fluid trap is located inside the housing and is able to be partially filled with fluid. The conduit has a first end coupled to the second opening of the gathering vessel and a second end to be submerged within fluid inside the fluid trap. The vacuum is located inside the housing, is coupled to the fluid trap, and removes air from the fluid trap to cause air and flies to flow from the gathering vessel, through the conduit, and into fluid inside the fluid trap. The timing device is located inside the housing, is electronically coupled to the vacuum, and periodically activates and deactivates the vacuum.

In some embodiments, the gathering vessel is attached to the outside of the housing, and in others, the gathering vessel is located inside the housing, where the first opening of the gathering vessel is an opening in the housing. In many embodiments, the fluid trap is able to be removed from the housing.

Another example embodiment of the present invention is a fly trap that includes a central fluid trap, multiple gathering vessels, multiple conduits, a vacuum, and a timing device. The central fluid trap is able to be partially filled with fluid. The multiple gathering vessels each include a container to hold fly-attracting bait, a first opening allowing the flies to enter the gathering vessel, and a second opening allowing for collection of the flies. The multiple conduits each have a first end coupled to the second opening of a corresponding gathering vessel, and a second end coupled to a common conduit to be submerged within fluid inside the central fluid trap. The vacuum is coupled to the fluid trap and removes air from the fluid trap to cause air and flies to flow from the gathering vessels, through the conduits, and into fluid inside the central fluid trap. The timing device is electronically coupled to the vacuum and periodically activates and deactivates the vacuum.

In many embodiments, the multiple gathering vessels are located at locations remote from the central fluid trap. In some embodiments, a hub may be used to couple the multiple conduits to the common conduit, and the hub can include a switch that activates and deactivates various conduits. The switch may also cycle through the multiple conduits, activating a subset of the conduits at a given time.

Another example embodiment of the present invention is a fly trap that includes multiple gathering vessels, multiple fluid traps, multiple collection conduits, a central vacuum, and a timing device. The multiple gathering vessels each include a container for fly-attracting bait, a first opening allowing the flies to enter the gathering vessel, and a second opening allowing for collection of the flies. The multiple fluid traps each are able to be partially filled with fluid. The multiple collection conduits each have a first end coupled to the second opening of a corresponding gathering vessel, and a second end to be submerged within fluid inside a corresponding fluid trap. The central vacuum is coupled to the fluid traps and removes air from the fluid traps to cause air and flies to flow from the gathering vessels, through the collection conduits, and into fluid inside the fluid traps. The timing device is electronically coupled to the vacuum and periodically activates and deactivates the vacuum.

In many embodiments, the multiple gathering vessels and fluid traps are located at locations remote from the central vacuum. In some embodiments, a hub may be used to couple the multiple fluid traps to the central vacuum, where the hub is coupled to the multiple fluid traps by multiple vacuum conduits, and is coupled to the vacuum by a common conduit. The hub can include a switch that activates and deactivates various conduits, and that can cycle through the multiple vacuum conduits, activating a subset of the vacuum conduits at a given time.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is a schematic drawing of a fly trap, according to an example embodiment of the present invention.

FIG. 2 is a schematic drawing of a fly trap contained within a housing, according to an example embodiment of the present invention.

FIG. 3 is a schematic drawing of a fly trap with multiple gathering vessels, according to an example embodiment of the present invention.

FIG. 4 is a schematic drawing of a fly trap with multiple gathering vessels and fluid traps, according to an example embodiment of the present invention.

FIG. 5 is a schematic drawing of a fly trap with multiple gathering vessels and fluid traps, according to an example embodiment of the present invention.

### DETAILED DESCRIPTION OF THE INVENTION

A description of example embodiments of the invention follows.

The fly trap in its various configuration disclosed herein employs a two-step process to remove unwanted flies from the local environment. The first step is a lure using, for example, a household and non-toxic attractant, such as apple cider vinegar, attracting flies in the local environment to the trap. The second step is an intermittent suction effect used to physically pull the flies from the area around the lure into the trap vessel, completing the removal of pests from the area. The fly trap uses a collection of devices, including a physical trap, a vacuum, and an electronic intermittent timer.

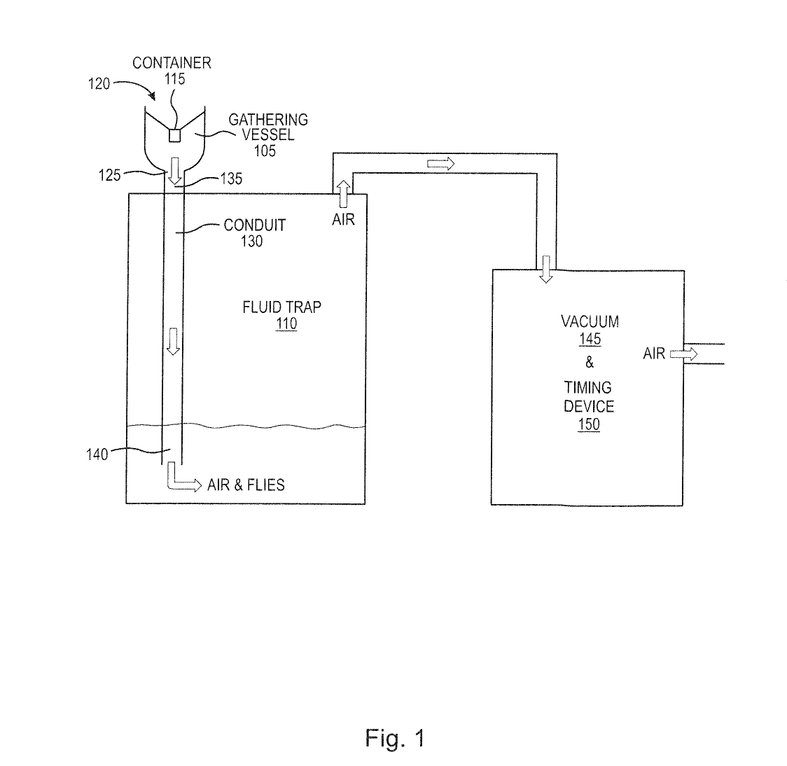

FIG. 1 is a schematic drawing of a fly trap, according to an example embodiment of the present invention. On the left side of FIG. 1, a physical trap is shown. At the top of the trap is a gathering vessel 105 in the shape of a cylindrical funnel, which contains a lure in a container 115. The gathering vessel 105 has a first opening (e.g., wide-mouth) 120 facing upwards with a small container 115 suspended within, holding the fly attractant. Trusses that support the suspended lure container 115 may also function as surface area for flies to land on around the lure. In the particular embodiment shown, a second opening (e.g., lower tip) 125 of the gathering vessel 105 is inserted into the top of a fluid trap 110 and connects to the top 135 of a conduit (e.g., tube) 130 running down most of the height of the chamber of the fluid trap 110. Water, for example, may be used inside the body of the fluid trap 110 to fill the bottom, submerging the output 140 of the conduit (intake tube) 130 under water. When the vacuum is active the intake tube 130 leads flies from the gathering vessel 105 into the body of the fluid trap 110, the force of which disables and submerges the flies in the fluid trap 110. At the top of the trap, for example, is another tube, leading from inside the chamber of the fluid trap 110 to the outside. This tube connects to a vacuum system 145 that creates negative pressure inside the body of the fluid trap 110, pulling flies from the gathering vessel 105 into the water below. One aspect of the trap's effectiveness is an intermittent timer 150 that controls when the vacuum 145 is active. Activation of the suction on an interval accomplishes several things. Operation is automatic and requires no supervision. The trap is more effective when run on an interval because flies are allowed to collect near the lure without being disturbed, then the vacuum is activated and the trap is active for a short amount of time. Success has been achieved with a 15-minute off/1-minute on interval, for example. The system also saves power because the vacuum is only in operation for one minute, four times an hour, for example; thus, the impact on power cost is minimal.

An example embodiment of the device may function as follows. The interior of the fluid trap 110 can be filled with approximately two inches of water, submerging the output side 140 of the intake tube 130. A drop of dish soap may be added to the water to reduce surface tension of the water and ensure flies are quickly saturated when pulled into the water. The bubbles also help dispatch the flies. The lure of the gathering vessel 105 may be prepared by adding a non-toxic natural attractant, such as vinegar or fruit juice, to the container 115. The vacuum 145 can be attached to an output tube at the top of the fluid trap 110, and be connected to an electronic timer 150, which controls automatic operation of the vacuum 145. The device is placed in an area where flies have become a problem, plugged in (or operated by battery), and left to operate for a time (e.g., overnight), trapping the pests and cleaning the environment. A user may then simply remove a lid of the fluid trap 110, empty the fluid trap 110 into a sink or toilet, and the trap is ready to be cleaned and refilled for re-use, if needed.

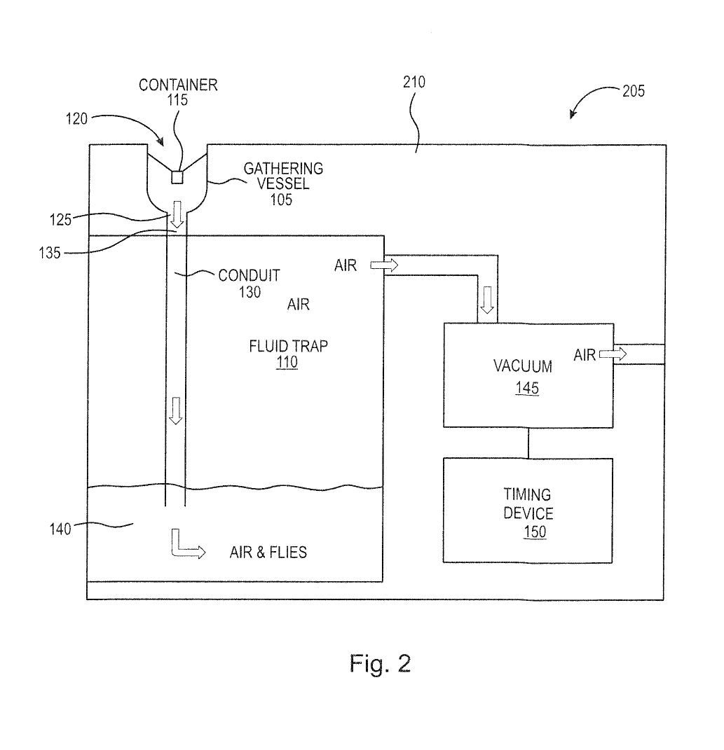

FIG. 2 is a schematic drawing of a fly trap contained within a housing 210, according to an example embodiment of the present invention. As a manufactured product, the device could be packaged in a self-contained unit 205, as shown in FIG. 2. In FIG. 2, the gathering vessel 105, fluid trap 110, vacuum 145, timing device 150, and related components are all contained within a housing 210. While the gathering vessel 105 is shown as being located inside the housing 210, with the first opening 120 of the gathering vessel 105 being an opening in the housing 210, the gathering vessel 105 can alternatively be attached to the outside of the housing 210, similar to the gathering vessel of FIG. 1. The overall functionality of the trap remains the same, but such a purpose-built version of the trap would allow the device to be employed even during business hours, in public areas. Using a vacuum 145 that is properly scaled in power and quieted with baffles, the device could come in multiple versions appropriate for different environments. A low-power version could be used for home or in social businesses, such as a bar, small restaurants, and grocery stores. In such areas a primary concern would be non-intrusive operation. A higher-power version could be available for commercial kitchens, health-care facilities, breweries, distilleries, and fruit growing and processing locales, where sound or power usage is less of a concern and airborne pests may be more numerous.

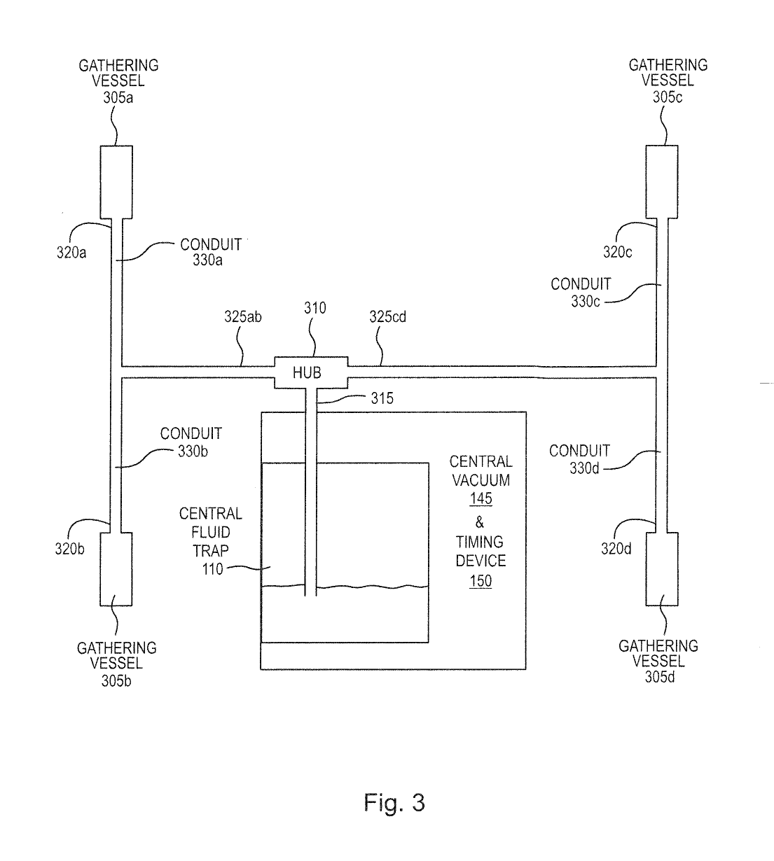

FIG. 3 is a schematic drawing of a fly trap with multiple gathering vessels 305a-d, according to an example embodiment of the present invention. A modular system can be employed, with a central vacuum 145 being attached to multiple gathering vessels 305a-d. This could be used at a bar, for example, with the trap out of view (e.g., behind the bar), and small gathering vessels placed near sinks or garnish trays. This configuration could also be used on a much larger scale, such as in an orchard. In such a configuration, the trap includes a central fluid trap 110, multiple gathering vessels 305a-d, multiple conduits 330a-d, a central vacuum 145, and a timing device 150. The multiple conduits 330a-d each have a first end 320a-d coupled to a corresponding gathering vessel 305a-d, and a second end 325a-d coupled to a common conduit 315 to be submerged within fluid inside the central fluid trap 110. As shown in FIG. 3, a hub 310 may be used to couple the multiple conduits 330a-d to the common conduit 315. The hub 310 may also include a switch (not shown) that activates and deactivates various conduits, and that can cycle through the multiple conduits, activating a subset of the conduits at a given time and allowing the device to use a lower-power vacuum but still handle multiple trap locations.

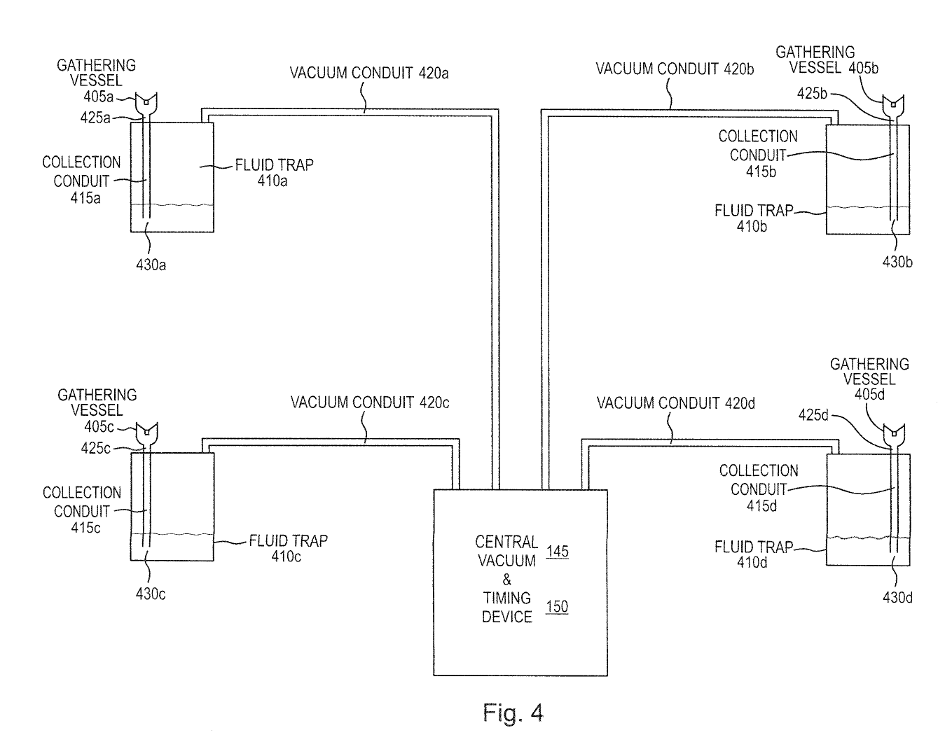

FIG. 4 is a schematic drawing of a fly trap with multiple gathering vessels 405a-d and fluid traps 410a-d, according to an example embodiment of the present invention. A modular system can be employed, with a central vacuum 145 being attached to multiple gathering vessels 405a-d and multiple fluid traps 410a-d. In such a configuration, the trap includes multiple gathering vessels 405a-d, multiple fluid traps 410a-d, multiple conduits 415a-d, a central vacuum 145, and a timing device 150. The multiple conduits 415a-d each have a first end 425a-d coupled to a corresponding gathering vessel 405a-d, and a second end 430a-d to be submerged within fluid inside a corresponding fluid trap 410a-d. Each of the fluid traps 410a-d is coupled to the vacuum 145 of the system by a corresponding vacuum conduit 420a-d.

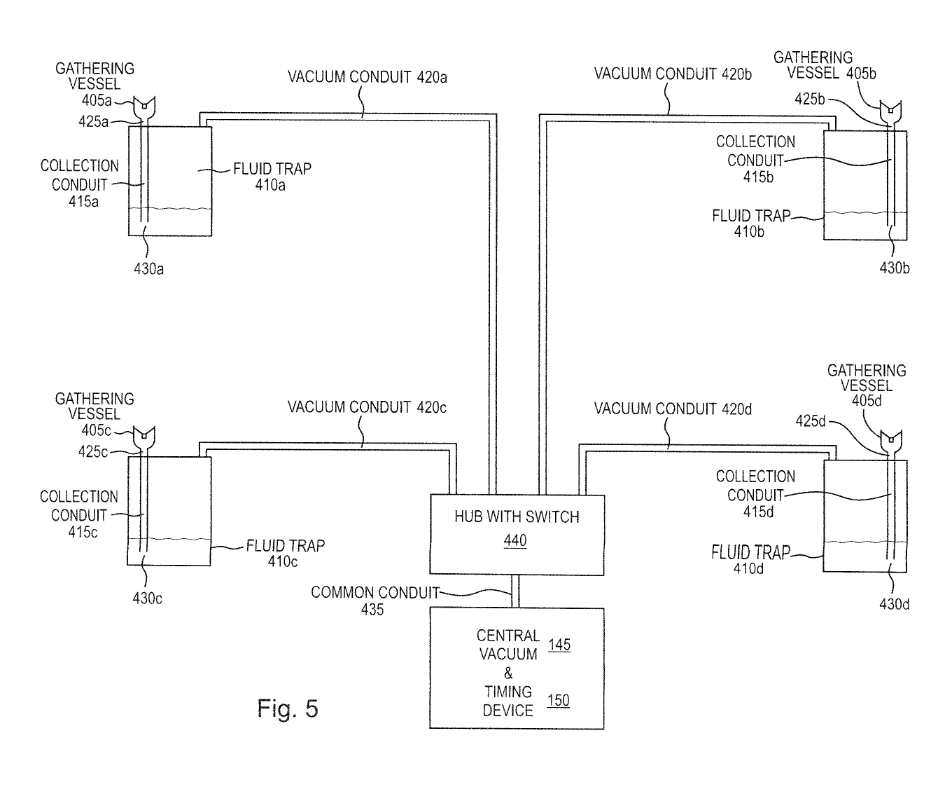

FIG. 5 is a schematic drawing of a fly trap with multiple gathering vessels 405a-d and fluid traps 410a-d, according to an example embodiment of the present invention. The trap system of FIG. 5 is similar to the system of FIG. 4, except that the vacuum conduits 420a-d are coupled to the vacuum 145 using a hub 440 and common conduit 435. The hub 440 of the particular embodiment also includes a switch that activates and deactivates various vacuum conduits 420a-d. The switch may also cycle through the multiple vacuum conduits 420a-d, activating a subset of the vacuum conduits 420a-d at any one time, allowing the system to use a lower-power vacuum 145 but still handle multiple trap locations.

While this invention has been particularly shown and described with references to example embodiments thereof, it will be understood by those skilled in the art that various changes in form and details may be made therein without departing from the scope of the invention encompassed by the appended claims.

For example, there may be many variations in the size and shape of the gathering vessel. For example, the width and depth of the vessel can vary, platforms can be added for flies to land on or near the bait, or multiple partitions may be used for multiple bait types. Various aerodynamic shapes of the funnel, lure container, and suspension trusses can increase effectiveness at a given power level. Programmable timers may be used, allowing a user to customize the operating intervals to better suit particular needs. Variations in bait used and the design of the gathering vessel could allow the device to be effective on flying pests besides fruit flies, including mosquitos and bees, for example.

What is claimed is:

1. A fly trap, comprising:
a gathering vessel including a container configured to hold bait to attract flies, a first opening allowing the flies to enter the gathering vessel, and a second opening allowing collection of the flies;
a fluid trap configured to be partially filled with fluid;
a conduit with a first end being coupled to the second opening of the gathering vessel, and a second end configured to be submerged within fluid inside the fluid trap;
a vacuum coupled to the fluid trap and configured to remove air from the fluid trap to cause air and flies to flow from the gathering vessel, through the conduit, and into fluid inside the fluid trap; and
a timing device electronically coupled to the vacuum and configured to periodically activate and deactivate the vacuum.

2. A fly trap as in claim 1 wherein the container is suspended inside the gathering vessel.

3. A fly trap as in claim 1 wherein the gathering vessel further includes a platform near the container for the flies to land.

4. A fly trap as in claim 1 wherein the interior of the gathering vessel includes a low-friction surface.

5. A fly trap as in claim 1 wherein the timing device is configured to activate the vacuum for a first amount of time and deactivate the vacuum for a second amount of time, the second amount of time being longer than the first amount of time.

6. A fly trap, comprising:
a housing;
a gathering vessel coupled to the housing, the gathering vessel including a container configured to hold bait to attract flies, a first opening allowing the flies to enter the gathering vessel, and a second opening allowing collection of the flies;
a fluid trap located inside the housing and configured to be partially filled with fluid;
a conduit with a first end being coupled to the second opening of the gathering vessel, and a second end configured to be submerged within fluid inside the fluid trap;
a vacuum located inside the housing and coupled to the fluid trap, the vacuum being configured to remove air from the fluid trap to cause air and flies to flow from the gathering vessel, through the conduit, and into fluid inside the fluid trap; and
a timing device located inside the housing, the timing device being electronically coupled to the vacuum and configured to periodically activate and deactivate the vacuum.

7. A fly trap as in claim 6 wherein the gathering vessel is attached to the outside of the housing.

8. A fly trap as in claim 6 wherein the gathering vessel is located inside the housing, the first opening of the gathering vessel being an opening in the housing.

9. A fly trap as in claim 6 wherein the fluid trap is removable from the housing.

10. A fly trap as in claim 6 wherein the container is suspended inside the gathering vessel.

11. A fly trap as in claim 6 wherein the gathering vessel further includes a platform near the container for the flies to land.

12. A fly trap as in claim 6 wherein the interior of the gathering vessel includes a low-friction surface.

13. A fly trap as in claim 6 wherein the timing device is configured to activate the vacuum for a first amount of time and deactivate the vacuum for a second amount of time, the second amount of time being longer than the first amount of time.

14. A fly trap as in claim 6 wherein the vacuum includes baffles to reduce noise emitted from the vacuum.

15. A fly trap, comprising:
a central fluid trap configured to be partially filled with fluid;
multiple gathering vessels, each including a container configured to hold bait to attract flies, a first opening allowing the flies to enter the gathering vessel, and a second opening allowing collection of the flies;
multiple conduits, each having a first end being coupled to the second opening of a corresponding one of the gathering vessels, and a second end coupled to a common conduit configured to be submerged within fluid inside the central fluid trap;
a vacuum coupled to the fluid trap and configured to remove air from the fluid trap to cause air and flies to flow from the gathering vessels, through the conduits, and into fluid inside the central fluid trap; and
a timing device electronically coupled to the vacuum and configured to periodically activate and deactivate the vacuum.

16. A fly trap as in claim 15 wherein the gathering vessels are located at locations remote from the central fluid trap.

17. A fly trap as in claim 15 further including a hub coupling the multiple conduits to the common conduit.

18. A fly trap as in claim 17 wherein the hub includes a switch configured to activate and deactivate various ones of the multiple conduits.

19. A fly trap as in claim 18 wherein the switch is further configured to cycle through the multiple conduits, activating a subset of the conduits at a given time.

20. A fly trap, comprising:
multiple gathering vessels, each including a container for bait to attract flies, a first opening allowing the flies to enter the gathering vessel, and a second opening allowing collection of the flies;
multiple fluid traps, each configured to be partially filled with fluid;
multiple collection conduits, each having a first end being coupled to the second opening of a corresponding one of the gathering vessels, and a second end configured to be submerged within fluid inside a corresponding one of the multiple fluid traps;
a central vacuum coupled to the fluid traps and configured to remove air from the fluid traps to cause air and flies to flow from the gathering vessels, through the collection conduits, and into fluid inside the fluid traps; and
a timing device electronically coupled to the vacuum and configured to periodically activate and deactivate the vacuum.

21. A fly trap as in claim 20 wherein the gathering vessels and fluid traps are located at locations remote from the central vacuum.

22. A fly trap as in claim 20 further including a hub coupling the multiple fluid traps to the central vacuum, the hub being coupled to the multiple fluid traps by multiple vacuum conduits and being coupled to the vacuum by a common conduit.

23. A fly trap as in claim 22 wherein the hub includes a switch configured to activate and deactivate various ones of the multiple vacuum conduits.

24. A fly trap as in claim 23 wherein the switch is further configured to cycle through the multiple vacuum conduits, activating a subset of the vacuum conduits at a given time.
